(19) United States
(12) Patent Application Publication
(10) Pub. No.: US 2001/0038070 A1
(43) Pub. Date: Nov. 8, 2001

(54) Multiplex sequence variation analysis of DNA samples by mass spectrometry

(76) Inventors: Felix Hausch, Stanford, CA (US); Andres Jaschke, Berlin (DE)

Correspondence Address: KUDIRKA & JOBSE, LLP, ONE STATE STREET, SUITE 1510, BOSTON, MA, 02109, US

(21) Appl. No.: 09/817,905

(22) Filed: Mar. 26, 2001

(30) Foreign Application Priority Data
Mar. 28, 2000 (DE) 100 15 797.1

(51) Int. Cl. H01J 49/00; B01D 59/44

(52) U.S. Cl. 250/288

(57) ABSTRACT

The invention relates to the simultaneous analysis of variations in distinct nucleic acid sequences within a complex nucleic acid mixture. The invention consists in the use of chips with spatially separated fields of photocleavable oligonucleotide probes which are commonly processed together with the target sequences and thereby modified in a sequence-dependent way. The probes are cleaved and analyzed by laser desorption mass spectrometry. This allows highly parallel and nevertheless sequence-specific reactions within a single reaction mixture. Since the photocleavable oligonucleotide probes are placed on a substrate in a spatially defined manner, e.g. in the form of an array, a specific target sequence can be assigned a unique position on the oligonucleotide chip. Since the photocleavable probes are covalently immobilized on the solid surface, the detection reaction can be performed directly on the chip while preserving the probe position pattern. Due to the presence of a photosensitive residue within the probes, these can be controlled photolytically after the detection reaction so that a mass spectroscopic analysis can then be carried out.

### FIELD OF INVENTION

The invention relates to the simultaneous investigation of variations of distinct nucleic acid sequences within a complex nucleic acid mixture of a DNA sample by mass spectrometry.

### PRIOR ART

With the continuously increasing amount of sequence information from the various sequencing projects currently being undertaken, and the growing number of completely elucidated genomes, genetic studies have shifted more towards reproducible or secondary sequence analysis based on already known sequences. Currently the genomes from over 25 organisms have been completely elucidated, and the human genome as well as many others will be added to this list in the coming years. The information obtained in this way can be used repeatedly and directly for analyzing specific characteristics, e.g. for detecting sequences which are specific for disease pathogens. Genetically determined diseases or disease predispositions can often be attributed to specific mutated gene sequences. Human medicine is currently aware of more than 3000 monogenic diseases induced by alterations in single genes. Sometimes a pathogenic characteristic can be attributed to a mutation of a single nucleotide. During the course of the Human Genome Project (HUGO) this number will increase further and will indeed be extended by multigenic factors.

The growing number of relevant gene markers sets new standards for nucleic acid diagnostics. Classical sequencing by the Sanger procedure, employed for the original sequencing of the currently elucidated genomes, is unsuitable here since it is time-consuming and can not be completely automated.

With the development of gentle mass spectroscopic procedures which permit the analysis of large, intact biomolecules, a highly promising alternative has now become available. In this way, MALDI TOF MS (MALDI=Matrix Assisted Laser Desorption/Ionization; TOF=Time-Of-Flight; MS=mass spectrometry) can directly determine the molecular weight of nucleic acids (Hillenkamp and Karas, 1990, Methods in Enzymology, 280). Unlike classical Sanger sequencing by PAGE (PolyAcrylamide Gel Electrophoresis), the sequence-specific fragment ladder of a DNA sample is reported with a single mass value. This technique has already been successfully employed to sequence the human p53 gene (Fu et al 1998, Nat. Biotechnol., 381), and in U.S. Pat. No. 5,777,324 (F. Hillenkamp, 1996) a promising device has been put forward for this purpose. Through improvement of the measuring conditions (gentler excitation in the IR range, neutral matrix), it has become possible recently to measure much larger DNA molecules with over 2,500 nucleotides (Berkenkamp et al., 1998, Science, 260). As a result the reading and measurement accuracy with mass spectrometric sequencing should markedly improve (WO 99/57318). In this context, one should also mention the importance of using stable or isotopically pure nucleotide analogs (WO 96/27681, I. Gut et al.). A procedure for a more precise mass spectroscopic DNA sequencing through the use of internal calibration is put forward in WO 95/14108 (M. A. Reeve et al.).

The diagnostics of already known genes has been substantially simplified by the development of so-called DNA chips (Gerhold et al. 1999, Trends in Biochemical Sciences, 168-173). On such a chip, surface areas are functionalized with oligonucleotides that are complementary to the genetic material to be analyzed. As a rule, oligonucleotide markers are organized in an array so that hybridization at a particular position can confirm the presence of a corresponding sequence within the biological sample (Fodor, 1997, Science, 393-395). The evaluation of the hybridization test is usually performed by fluorescence marking of the samples and scanning of the DNA chip. The major advantage of DNA analysis using DNA chips is the high throughput; ie. on a 1.6×1.6 cm chip up to 137,000 oligonucleotides can be placed and read within 10 minutes (Chee et al. 1996, Science, 610-614). The fluorescence analysis of the hybridized sampies, however, does not permit any further acquisition of information regarding the target sequence. Furthermore, the hybridization efficiency is dependent on the base composition and is significantly influenced by secondary structures; as a result, only relative statements can be made usually (i.e. comparisons with internal standards). Apart from that, individual mismatches are tolerated, and these can only be excluded by extensive control experiments.

The mass spectrometric evaluation of DNA chips offers the general benefit that apart from providing information about the presence of investigated nucleic acid sequences, additional information can be obtained regarding their molecular weight. This third dimension of measurement (as a supplement to the two dimensional localization on the chip) can be introduced for internally controlling the hybridized DNA probes. With mass spectroscopic DNA sequencing this has already been exploited elsewhere for an extra controlling of the measured nucleic acid fragments and interpreting the observed sequence ladder (Kirpekar et al., 1998, Nucleic Acids Research, 2554-2559).

Since with MALDI TOF MS measurements the nucleic acid fragments are presented on a flat surface, this method is particularly suitable for the rapid evaluation of nucleic acid chips. The nucleic acids to be measured are first enclosed in a solid, organic matrix, which is then desorbed from the surface by a pulse of laser light. In this process isolated nucleic acids are carried away as a matrix cluster into the gas phases, ionized by the dissolving organic phase and then detected by their characteristic time of flight in the electrical field. With the laser stimulation, individual points within the DNA arrays can be evaluated in a targeted fashion. Such a concept is described in WO 94/16101 (H. Köster) whereby the samples to be investigated are immobilized on an appropriate surface and then incubated with an oligonucleotide marker. Such probes are if necessary sequence-specifically modified before they are detected by MALDI TOF mass spectrometry. This requires a separate purification and targeted positioning for each of the DNA samples to be investigated. Because of the sheer numbers of samples to be studied—e.g. all 3000 important point mutations currently known—a considerable effort is involved in the analysis. For this reason nucleic acid modifications are recommended which simplify a covalent immobilization of the samples onto the chip (WO 98/20020, O'Donnell et al.). Photocleavable residues have also been described as supplementary modifications for MALDI TOF measurements.(Olejnik et al., 1998, Nucleic Acids Research, 35723576), which enable a light-regulated release of samples. The use of photocleavable sites was similarly suggested in WO 98/20166 (Koster et al.), so that detection reactions could be carried out individually for each sample and that these reaction mixtures could be spotted in an array format on a MALDI TOF compatible chip. In this way a functional group on the nucleic acid probe allows a specific purification on a specially prepared surface while the photocleavable sites enable then a photolytic release for MALDI TOF MS detection. The use of lysable primers as DNA probes for mass spectroscopic sequencing is suggested also in WO 96/37630 (J. A. Montforte et al.)., whereby these should lead to a shortening of the measured nucleic acid fragments and thereby to an improved readability. The application of immobilized primers in a two-step amplification process is described in DE 19710166 (Gut, I. and Franzen J., 1998) whereby the automation and highly parallel processing of nucleic acids is promoted by binding to magnetic particles.

In general, covalently immobilized oligonucleotide probes convey the benefit of an improved and easier handling. In this way the most often varied reaction conditions including denaturing, washing, or temperature changes are enabled, Le. conditions necessary for solid phase enzyme reactions in particular. Covalently immobilized probes are not, however, accessible for MALDI TOF analysis since they can not be desorbed from the surface substrate.

The detection of nucleic acids by hybridization offers the unique opportunity, consistent with the Watson Crick base pairing rule, to generate complementary oligonucleotide probes for any target sequence. At least from a biological standpoint, such an interaction is relatively nonspecific. Sporadic mismatches are tolerated or can be overlain by other effects such as unusually stable secondary structures (e.g. those with a high G-C composition). However, when sequencing or detecting mutations of single, critical nucleotides (SNP=Single Nucleotide Polymorphism), a reproducible and reliable resolution of single bases is crucial Enzymatic transformations are clearly superior here to simple hybridization. Restriction enzymes only cut a recognition sequence at a defined position dependent on the methylation pattern. Endonucleases chiefly hydrolyze single nucleotides and DNA ligases are very fastidious about perfect base-pairing at the ligation site. DNA polymerases often possess an additional proof reading activity which can correct their own mistakes. This principle is utilized with classical DNA detection procedures such as polymerase chain reaction (PCR), ligase chain reaction (LCR), RNA footprinting or Sanger sequencing.

Regarding the detection of immobilized nucleic acids, enzymatic modifications have also been recommended for specifically detecting individual nucleotides (GB 2308188, Minter, S. J., 1997). In WO 98/20166 (Köster et al.), detection of modified oligonucleotide probes is performed by mass spectrometry. In both cases the target sequence to be analyzed is immobilized on the solid phase, so that these have to be applied to the surface before each detection. If the oligonucleotide probe is immobilized, this occurs after modification so that purification is made easier.

With increasing knowledge of the genetic factors responsible for particular predispositions, diseases or health risks, the number of relevant nucleotides to be tested within a biological sample has also grown. With enzymatic detection this classically requires one reaction and detection per target sequence. Even with automation and parallel sample processing with an extremely high throughput, this requires considerable preparation.

By using combinations of processes, many similar reactions can be performed parallelly in a single reaction step. Thus, with multiplex PCR, various DNA segments from a biological sample can be simultaneously amplified in a single reaction mixture through addition of a range of primer pairs. In any such reaction mixture, the problem is then usually shifted to find separate detection methods to unravel the complex sequence mixture. In order to suppress the enrichment of unwanted nucleic acids especially when studying severely underrepresented sequences, a nested PCR procedure can be used. With this technique the specificity is doubled in a two-step amplification by using two primer pairs boxed into each other.

### OBJECTIVE OF THE INVENTION

The invention should combine, for the investigation of variations in preselected DNA sequences, the highly parallel sample throughput of oligonucleotide chips, the detection specificity of template-dependent modifications, and the high amount of information associated with mass spectrometric detection, in a multiplex analysis with the assistance of photolytically cleavable oligonucleotide probes.

A main objective of the invention is to check a set of relevant (and preferably all) point, insertion, or deletion mutations in a patient in a single reaction step.

### SUMMARY OF THE INVENTION

It is a basic idea of the invention to use spatially separated, photocleavable oligonucleotide probes on a chip, and to perform multiplex sequence-dependent modification of the oligonucleotide probes, enabling the mass spectrometric detection of the target sequence variations by measuring the masses of the modified, detached probes directly on the chip, whereby the complex target sequence mixture is spatially separated due to the defined positions of the oligonucleotide probes on the chip.

To increase the specificity and to enable correct detection of target sequence variations, the oligonucleotide probes should be enzymatically modified dependent on the particular target sequences. Covalent immobilization of the oligonucleotide probes allows to undertake the required processes and reactions without muddling the probes. The processes and reactions are performed particularly by temperature steps for hybridizing the target sequences on the probes and for subsequent enzymatic modifications, by denaturing solvents for efficient washing and separation of contaminating traces of nucleic acids, and by extreme pH conditions during uptake into the MALDI TOF matrix. Because of the potential for acquiring extra information, detection is performed by mass spectrometry (particularly by MALDI TOF MS), which is enabled by photolytically susceptible cleavage sites on the oligonucleotide probes.

The photocleavable oligonucleotide probes include nucleic acids 5 to 100 nucleotides long (usually 20 to 25 nucleotides long) consisting of DNA, RNA, PNA, or their derivatives, which are complementary to target sequences and which hybridize to the nucleotides under investigation either at their ends, in the middle, or exactly in position. Photocleavable oligonucleotide probes also contain a photolytically susceptible site which can be selectively cleaved by the influence of light, usually o-nitrobenzyl groups. Target sequences as understood in the sense of this invention are genetic zones which might contain relevant mutations, e.g. single nucleotide polymorphisms (SNPs). Template-dependent modifications are transformations, usually enzymatic transformations, of the oligonucleotide probes which only occur upon hybridization of a specific sequence, so that by modifying the probes one can obtain information about details of the target sequence. Oligonucleotide arrays as understood in this invention are surfaces (usually on chips) with 10 to 100000 (typically 100 to 1000) spatially separated locations whereby each location is functionalized with a specific type of oligonucleotide probe.

Another basic idea of the invention is that the template-dependent modification of the probes and the mass spectroscopic detection should take place on the same surface. Hence, photolytic release from the solid substrate and desorption from the matrix can occur simultaneously by a laser pulse so that individual positions of the photocleavable oligonucleotide chips can be read one after the other, preferably in a photolytic manner.

It is characteristic for the invention that the surface fixing of the photocleavable probes occurs before the probe modification for detection, and that the immobilized oligonucleotide probes rather than the hybridized target sequences are enzymatically modified.

Template-controlled modification of oligonucleotide probes is understood as enzymatic alteration dependent on a hybridized target sequence, whereby such changes can later provide information about the nucleotide composition of the target sequence. The invention is partially based upon enzymatic modifications accomplished by a template-dependent primer elongation of the oligonucleotide probes. This explicitly includes point mutation analysis or chain terminating sequencing using dideoxynucleotide triphosphates.

Another basic idea of the invention is to achieve enzymatic detection by template-dependent DNA ligation, whereby the reporter oligonucleotides to be ligated are added to the detection reaction as a combined mixture.

Reporter nucleotides are nucleic acids 5 to 100 nucleotides long—chiefly 20 to 25 nucleotides long—primarily consisting of DNA, RNA, PNA, or their derivatives, which are complementary to a section adjacent to the immobilized oligonucleotide probes on the appropriate target sequence. Only with perfect base pairing at the interface between the oligonucleotide probes and reporters will DNA ligation occur, and because of this the base composition of the target sequence at the interface can be determined. The invention is designed so that the sequence specificity of the detection is raised due to the additional hybridization of the reporter oligonucleotides, and that especially insertion and deletion mutations can be detected in this way. A further idea of the invention is that the reporter oligonucleotides should carry an additional recognition group, permitting a simplified or alternative detection. Such groups might include mass, fluorescence, or affinity markers or even another light sensitive group. The reporter oligonucleotides can also contain stabilized or neutralized nucleotides for a more efficient mass spectroscopic detection.

Another basic idea of the invention is to determine the composition of the target sequence by template-dependent nucleotide cleavage of the oligonucleotide probes. This includes especially a template-dependent restriction digest, whereby the methylation pattern of the target sequences in particular can be reported. For this purpose a combined mixture of different restriction enzymes is the preferred method of choice. The invention uses endonucleases which cleave with a perfect base pairing or only a partial degree of mismatching. A preferred procedure involves oligonucleotide probes with a single, internal ribonucleotide, which can only be hydrolyzed for example by RNase H with perfect pairing to the investigated DNA counterstrand.

A main objective of the invention is to check a set of relevant (and preferably all) point, insertion, or deletion mutations in a patient in a single reaction step. This involves a pre-amplification of the relevant preselected target sequence sections by multiplex PCR using external primer pairs, a multiplex analysis by ligation of reporter oligonucleotides to photocleavable sites, as well as photolytic reading of the ligation products by a subsequent MALDI TOF detection. Thus, oligonucleotide reporters and probes explicitly lie within sequences enclosed by the external primers. Another main implementation of the invention involves the multiplex resequencing of already known genomes for the purpose of reporting clinically relevant mutations.

### BRIEF DESCRIPTION OF THE FIGURES

FIG. 1 describes the ensemble of target sequences which hybridize at the appropriate positions of the corresponding complementary oligonucleotide probes. P₁₋ₙ. X₁₋ₙ symbolizes the nucleotides to be checked in the multiplex analysis for relevant mutations. A₁₋ₙ and Z₁₋ₙ represent adjacent sequences which are introduced for positioning on the oligonucleotide chip and for the enzymatic detection reactions. The large parallelogram represents the surface of the chip upon which the oligonucleotide probes are imrnmobilized covalently via the spacers depicted as wavy lines. The black circles correspond to the photocleavable sites which permit a targeted release in response to a laser pulse with simultaneous detection of the modified oligonucleotide probes by MALDI TOF mass spectrometry.

FIG. 2 illustrates two methods for enzymatic detection involving template-dependent modification of the photocleavable oligonucleotide probes.

a) The partial sequence Zₙ of an exemplary target sequence hybridizes with a complementary oligonucleotide probe Pₙ. which is immobilized onto the solid substrate via a photocleavable linker depicted in the diagram as a wavy line (shown as a sphere). This is then elongated according to the tested nucleotide Xₙ by a DNA polymerase to form the complementary dideoxynucleotide Yₙ. The modified oligonucleotide probe YₙPₙ is then photolytically released at the photocleavage site (black circle) and measured by MALDI TOF spectrometry.

b) Insertion, deletion or point mutation analysis by template-dependent DNA ligation: the sequence excerpt XₙZₙ of a target sequence deposits itself on the immobilized oligonucleotide probe YₙPₙ, while the reporter oligonucleotide Bₙ hybridizes with the adjacent sequence excerpt Aₙ. If the target nucleotide X_{d} to be tested does not correspond to the probe terminus Yₙ, ligation can not take place, and the same applies when Xₙ is eliminated. Insertion mutants which present an extra nucleotide in Xₙ can still be identified by ligation of YₙPₙ oligonucleotide probes.

In FIG. 3, two typical potentially photocleavable oligonucleotide probes are depicted. Both contain a DNA fragment 19 nucleotides long for enzymatic detection by template-dependent modification and an o-nitrobenzyl residue for a targeted photolysis. This is held by flexible hexaethylene or polyethylene glycol spacers, which guarantee unimpeded access for hybridized target sequences or modifying enzymes. Both oligonucleotide probes also contain a functional group which enables immobilization on the solid phase substrate: a) anthracene as a diene in a Diels-Adler reaction with appropriate dienophiles, e.g. maleimide; b) a primary amino group for reaction with suitable active esters such as NHS ester; c) an o-nitrophenyl phosphoramidite residue is shown that can be utilized for generation of a photocleavage site within the photocleavable oligonucleotide probes.

FIG. 4a) shows the MALDI TOF mass spectroscopic analysis of the photocleavable oligonucleotide probe from FIG. 3a). The dominant peak with an m/e of 6189.9 is the signal for the photolytically released oligonucleotide fragment (calculation: [M+H]⁺=6190.0 g/mol). The molecular mass peak of the uncleaved oligonucleotide probe is only visible as trace readings between 7036.2 and 7300.0 g/mol and, due to the polydisperse nature of the polyethyleneglycol spacers, is split up into several peaks.

FIG. 4b) illustrates the immobilization and photolytic release of photocleavable nucleic acia conjugates: white columns=released nucleic acid; black columns=immobilized nucleic acid; track 1=inserted, radioactively marked, photocleavable nucleic acid conjugate; track 2=immobilized fraction after intensive, denaturing washing; track 3=photolytic release of the immobilized nucleic acid (black columns from track 2).

### PREFERRED EMBODYMENTS

The production of the photocleavable oligonucleotide arrays can on the one hand be performed by applying conventionally synthesized oligonucleotide conjugates to appropriately prepared surfaces. The microfluid pipetting or dispensing system required for this is well known to experts in this area. Oligonucleotide probes as required by the invention are mainly fixed on the surface covalently, preferably via a flexible spacer—particularly polyethylene glycol—whereby linking is usually performed at either the 3′ or the 5′ terminus of the oligonucleotide. The preferably used oligonucleotide conjugates also contain in addition to the photocleavable site another reactive functional group for covalent linking; e.g. biotin, amino, thiol carboxyl, or diene groups such as anthracene. Suitable photocleavable sites for the invention are chiefly light sensitive o-nitrobenzyl residues, particularly 1-o-nitrophenyl-1,3-propane-diphosphate. A selection of photocleavable oligonucleotide probes is depicted in FIG. 3.

On the other hand, photocleavable oligonucleotide probes can be synthesized directly on the surface, whereby suitable guidelines for this have been described elsewhere in the literature.

With both manufacturing processes the photocleavable sites can be applied alternatively as a surface-covering layer onto the solid substrate which can then be loaded and synthesized with the desired oligonucleotides at the appropriate positions.

Only two rather complex methods are descibed here as examples, but the detailed description allows the specialist in the field, supported by the knowledge transported by the invention, to easily derive other methods for his analytical task.

Multiplex Mutation Analysis by Ligation

Firstly, for each mutation point to be analyzed, two external amplification primers and one reporter nucleotide are synthesized by classical solid phase synthesis, whereby in each case one of the amplification primer 5′ terminals is derivatized with biotin.

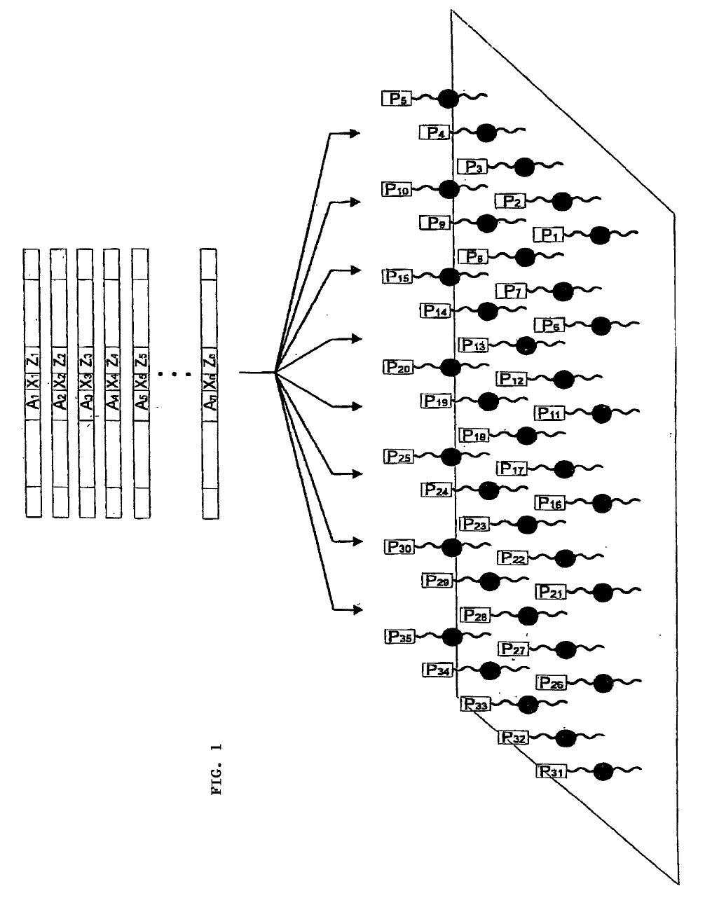

To make the array of photocleavable oligonucleotide probes, a DMTr polyethylene glycol functionalized glass substrate is eroded with trichloracetic acid and then treated over the entire surface with tetrazole and a 0.1M solution of photo-phosphoramidite (FIG. 3c) in acetonitrile. After repeated washing with acetonitrile, the non-reacted functional groups are blocked with acetic hydride, lutidine and 1-methylimidazole in THF, before treatment with a 1 M iodine solution in pyridine/THF/water. On this o-nitrobenzyl derivatized surface, the corresponding oligonucleotide sequences are synthesized at the appropriate positions using a surface synthesis robot (familiar to experts) in the format depicted in FIG. 1. Finally, these oligonucleotides are chemically phosphorylated across the entire surface using a 0.1M bis-cyanoethyl-N,N-diisopropyl-phosphoramidite (in CH₃CN) solution. For exposing the photocleavable oligonucleotide probes, the chip is incubated overnight at 55° C. in 33% NH₄OH.

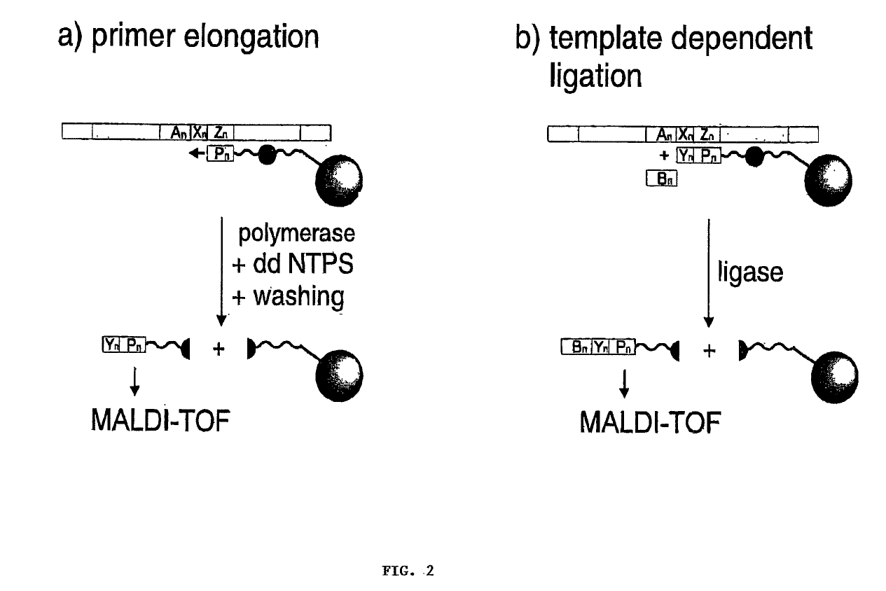

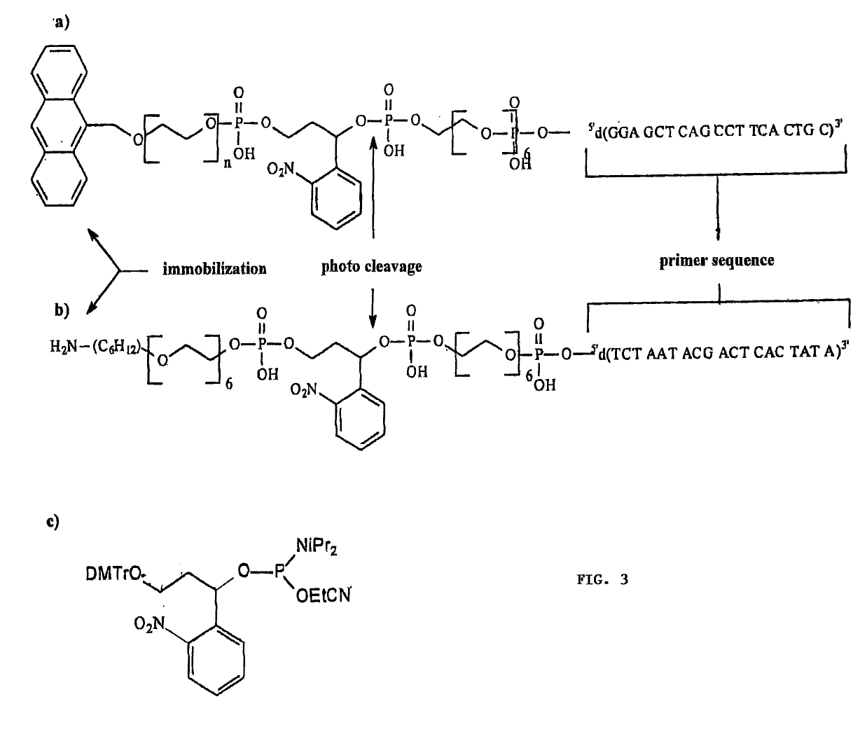

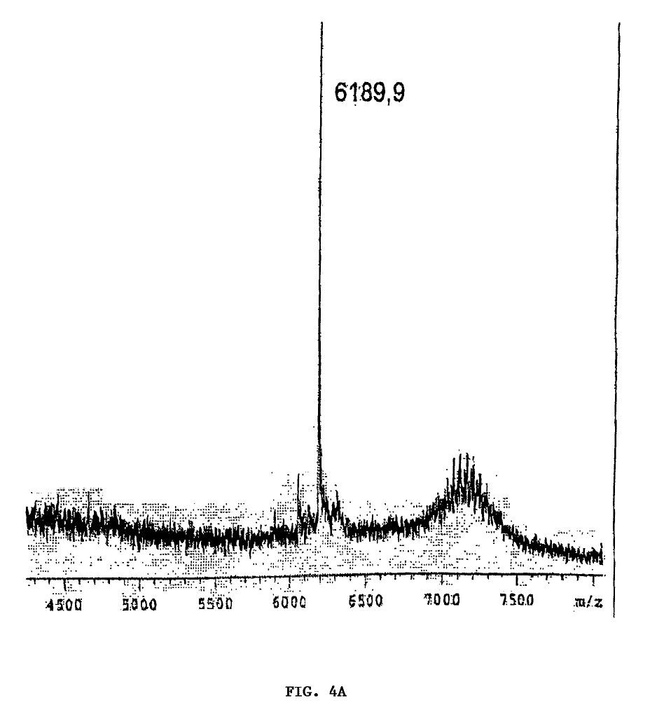

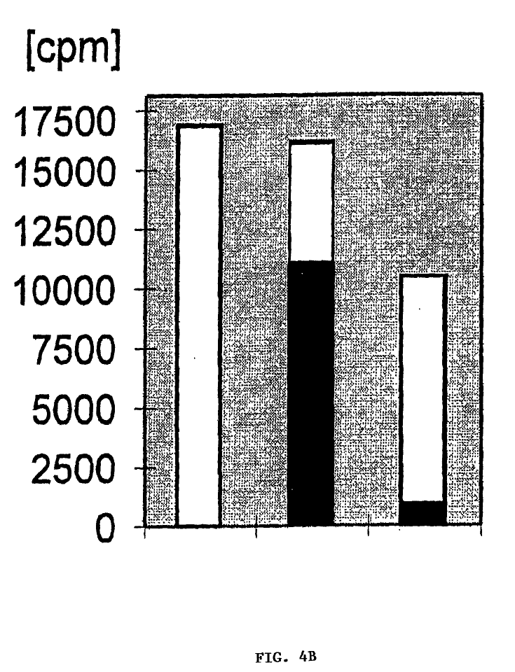

The genetic material is isolated from a biological sample of a patient, e.g. a hair root or a drop of blood, using standard procedures. All target sequences are selected by external primer pairs and are amplified using multiplex-PCR in a single reaction mixture. The amplification products are purified on a solid streptavidin-agarose affnity phase using the biotinylated primer. The counterstrands are released into solution by washing in 0.1M NaOH, mixed after neutralization with a set of reporter oligonucleotides, and then applied to the chip (see FIG. 1). At an end-concentration of 20 mM Tris/HCl (pH=8.3), 50 mM KCl. 10 mM MgCl₂, 10 mM DTT, 1 mM EDTA, 1 mM NAD, 0.1% Triton X-100 and 1 U Tth DNA ligase, the ligation reaction is carried out as described in FIG. 2b) with 20 cycles of 30 sec at 95° C., 1 minute at 50° C. and 5 min at 70° C. The chip is then repeatedly washed with 25% DMSO and 0.2M ammonium hydroxide solution and covered finally with a 1 mm thick layer of 3-hydroxypicolinic acid solution which is evaporated to dryness. Using a Nd-YAG laser, the individual points are stimulated one after another at a wavelength of 355 nm and the released oligonucleotide probes (compare FIG. 4b) are measured by MALDI TOF mass spectrometry as shown in FIG. 4a). The signals are then evaluated for clinically relevant mutations using integrated software. Every step of the procedure can be automated.

Multiplex Resequencing on a Solid Phase

For multiplex sequencing of different sequences of a genetic sample, a set of photocleavable oligonucleotide probes is first synthesized by classical solid phase synthesis. They are chosen in such a way that one probe can be hybridized to the target sequence at intervals of 50 nucleotides, whereby the probes for the strand and counterstrand do not differ. The photocleavable oligonucleotide probes are constructed as shown in FIG. 3a The anthracene polyethylene glycol, the hexaethylene glycol spacer as well as the photocleavable o-nitrobenzyl residue are incorporated as corresponding derivatized phosphoramidites. Using the stock solution of these oligonucleotides, more than 10,000 multiplex sequencer reactions to the genetic target sequence can be carried out.

An amino derivatized surface is now functionalized evenly by treatment with 0.1 M maleinimidylhexanoate-NHS ester in DMF over the entire surface. The anthracene functionalized oligonucleotide probes (analogous with 3a) are then pipetted onto this maleinimide surface in 10 nl volumes in an array format using a commercially available gene spotting robot. The chip shown in FIG. 1 is freed of non-immobilized oligonucleotide probes by intensive washing after overnight incubation.

A genetic region from a biological sample, containing 250,000 base pairs, is now amplified by cloning and purified by standard procedures. The DNA obtained is distributed amongst four of the above-described chips and mixed with a sequencing mixture (sequenase, dATP, dGTP, dCTP, dTTP as well as each type of ddNTP). After 30 cycles of 15 seconds at 95° C., 15 seconds at 55° C., and 30 seconds at 72° C., the chip is repeatedly washed with 25% DMSO and 0.2M ammonium hydroxide solution and covered finally with a 1 mm thick layer of 3-hydroxypicolinic acid which is then evaporated to dryness. Using a Nd-YAG laser the individual points are stimulated one after another at a wavelength of 355 nm and the released oligonucleotide probes (compare FIG. 4b) are measured by MALDI TOF mass spectrometry as shown in FIG. 4a). The measured sequence ladders of the respective terminator nucleotides are evaluated using integrated software, whereby the termination products are checked by measuring their mass and if necessary corrected. After correlation of the strand and counter-strand results, the total sequence obtained is compared with already known data and in this way any deviant mutations can be recorded.

1. Method for the analysis of a sample of genetic material for detailed sequence information contained in a large set of distinct sequences of the sample (the “target sequences”), comprising the following steps:
(1) producing an amount of nucleic acid templates containing the target sequences by multiplexed amplification of the sample of genetic material,
(2) using a chip with spatially separated locations containing a photocleavable oligonucleotide probe each for each target sequence to be investigated, the probes covalently bound to the chip surface,
(3) modifying, in a single reaction vessel and by using the templates produced in step (1), all oligonucleotide probes on the chip synchronously in a template-dependent manner so that the information under investigation is transferred from the target sequences of the templates to the probes,
(4) cleaving and mass spectrometrically measuring the spatially separated probes, and
(5) extracting the detailed sequence information from the mass measurements of the probes.

2. The method according to claim 1, wherein the mass of the probes is measured in a time-off-fight mass spectrometer by ionization through laser desorption pulses.

3. The method according to claim 1, wherein the target sequences are amplified before analysis in a single-vessel reaction.

4. The method according to claim 1, wherein the immobilized probes on the solid substrate are purified from contaminations and released from the template nucleic acid by intensive and, if necessary, denaturing washing after modification.

5. The method according to claim 1, wherein the probes are released from the solid substrate by irradiation after modification and purification and thereby are made accessible for mass spectrometric analysis.

6. The method according to claim 2, wherein the photolytic cleavage of the oligonucleotide probes from the solid substrate surface occurs simultaneously with their desorption and ionization in the laser desorption pulse.

7. The method according to claim 5, wherein mass spectrometric detection is performed by MALDI-TOF.

8. The method according to claim 1, wherein the probes are immobilized on a surface suitable for MALDI-TOF spectrometry, the modification of the probes occurs at this surface, and the photolytic release occurs during the MALDI-TOF measurement.

9. The method according to claim 1, wherein the modification of the photocleavable probes occurs by a template-dependent primer elongation.

10. The method according to claim 9, wherein at least one dideoxynucleotide is inserted during the template-dependent primer elongation of the photocleavable probes.

11. The method according to claim 9, wherein the modification of the photocleavable probes occurs by a template-dependent ligation using suitable reporter oligonucleotides.

12. The method according to claim 11, wherein the template specificity of the ligation is raised additionally by the sequence of the reporter oligonucleotides.

13. The method according to claim 12, wherein insertion and deletion mutations are analyzed in particular by the additional template specificity of the reporter oligonucleotides.

14. The method according to claim 11, wherein the reporter oligonucleotides can carry an additional recognition group.

15. The method according to claim 14, wherein the recognition group consists of a mass, fluorescence, or affinity marker, or a photoactive group.

16. The method according to claim 1, wherein the modification of the photocleavable probe is performed by a template-dependent, endonucleolytic cleavage.

17. The method according to claim 16, wherein the endonucleolytic cleavage is performed by restriction enzymes.

18. The method according to claim 16, wherein methylation patterns of the target sequences can be analyzed by a template-dependent restriction digest of the photocleavable probes.

19. The method according to claim 18, wherein the endonucleolytic cleavage occurs using single-strand specific nucleases.

20. The method according to claim 16, wherein single strand mismatches of hybridizations between probes and target sequences can be identified by template-dependent nuclease digests of the photocleavable probes.

21. The method according to claim 16, wherein endonucleolytic cleavage occurs using double strand-specific nucleases.

22. The method according to claim 21, wherein the double strand-specific nuclease is RNase H.

23. The method according to claim 1, wherein the photocleavable oligonucleotide probes can contain at least one ribonucleotide.

24. The method according to claim 21, wherein the ribonucleotides of the photocleavable probes can only be template-dependently digested when there is perfect base pairing, leading to detection of the mismatch in the photocleavable probes.

25. The method according to claim 9, wherein the hybridization of the target sequences to the photocleavable oligonucleotide probes and their template-dependent modification can be performed cyclicly a number of times.

26. The method according to claim 25, wherein the enzymes utilized are heat stable and the reaction mixture can be repeatedly warmed directly on the chip.

27. The method according to claim 1, wherein the chip carries, on its surface, 10 to 100,000 spatially separated, photocleavable oligonucleotide probes.

28. The method according to claim 1, wherein the photocleavage site consists of an o-nitrobenzyl residue.

29. The method according to claim 27, wherein the photocleavable oligonucleotide probe is connected additionally to the surface via a spacer in such a way that the enzymatic modification of the probes is facilitated.

30. The method according to claim 27, wherein the probes are immobilized in an array format on the surface of the chip as photocleavable oligonucleotide conjugates.

31. The method according to claim 30, wherein the photocleavable oligonucleotide conjugates carry an additional functional group for immobilization.

32. The method according to claim 31, wherein the additional functional group consists of an amino, sulfhydryl, carboxyl group, biotin, anthracene or a diene.

33. The method according to claim 27, wherein the photocleavable oligonucleotide probe is synthesized directly on the surface.

34. The method according to claim 33, wherein initially the photocleavable sites are synthesized in unison, and then if necessary the spacers are synthesized.

35. Nucleic acid chips with photocleavable oligonucleotide probes according to claim 1.
